(19) United States
(12) Patent Application Publication
(10) Pub. No.: US 2025/0064042 A1
(43) Pub. Date: Feb. 27, 2025

(54) COVER FOR FISHING LURES AND HOOKS

(71) Applicant: Outdoor Innovation LLC, Massillon, OH (US)

(72) Inventors: Mark Perretta, Massillon, OH (US); Paul Metcalfe, Solon, OH (US); Scott Urban, Solon, OH (US)

(73) Assignee: Outdoor Innovation LLC, Massillon, OH (US)

(21) Appl. No.: 18/236,197

(22) Filed: Aug. 21, 2023

(51) Int. Cl. A01K 97/06

(52) U.S. Cl. CPC A01K 97/06; A01K 87/009

(57) ABSTRACT

A cover for hooks of fishing lures has a body having a first half and a second half, which are connected together by a resilient biased hinge. A plurality of teeth are formed on the first half and the second half and gaps are formed between each of the teeth. The first half and the second half each have a cavity for retaining one or more hooks of a fishing lure. The first half and the second half each have a sloped end face to facilitate removal of the hook and the fishing lure from the cover. Hooks and clips are provided for securing the cover to a fishing pole.

### BACKGROUND OF THE DISCLOSURE

This disclosure relates to fishing lures. More particularly, it relates to a cover or clip used with fishing lures and fishing rods which can cover and protect several hooks of fishing lures, such as, but not limited to treble hooks.

A hook at the end of the fishing lure when not in use would present safety issues. Also, some lures have several hooks which cannot be properly covered.

For example, some lures may have one, two or three hooks, such as, for example, treble hooks, which need to be covered when not in use.

A cover is needed to protect and cover hooks on fishing lures in order to prevent injury and snags. The cover is preferably attached or secured to a fishing rod or pole.

A problem with fish lures with hooks is that the hooks can get caught on a variety of items, such as carpet in the boat or vehicle, a person, other fishing equipment, clothing, a person's skin, etc.

Moreover, rods are difficult to transport with lures attached. There is a need for a cover which can cover all hooks of lures quickly, efficiently, easily, and conveniently.

Thus, there is a need for a fishing lure hook cover which overcomes the above-mentioned deficiencies and others while providing better overall results.

### SUMMARY OF THE DISCLOSURE

The cover of the present disclosure will house the hooks of a fishing rod to keep the hooks from snagging things when the user is not fishing. Covers are typically made of lightweight, yet durable material (e.g., plastic) and are usually inexpensive. They can be made in a variety of sizes, for hooks of different sized fishing lures.

The present disclosure provides a protective housing for a fishing lure which encloses all hooks of the fish lure, such as one, two or three (or more) fishing hooks attached to a line of the fishing pole to prevent the hooks from becoming entangled with other fishing pole lines, or being snagged in clothing or upholstery and causing injuries, and which also provides a separate and secure storage compartment for storing fishing lures.

A cover for hooks of fishing lures is provided which includes a body having a first half and a second half, wherein the first half and the second half are connected together by a resilient biased hinge. A plurality of teeth are formed on the first half and the second half wherein a gap is formed between each of the teeth. The first half and the second half each have a cavity for retaining one or more hooks of a fishing lure; and the first half and the second half each has a sloped end wall to facilitate egress of the hooks of the fishing lure.

Another aspect of the disclosure is to provide a cover for fishing lure hooks on a fishing rod which forms a protective housing to prevent damage to the hooks, as well as preventing the hooks from becoming entangled with other lines or from causing accidental puncture wounds.

Another aspect of the disclosure is a cover which can cover hooks quickly and efficiently, easily, in a convenient manner (such as fitting into a pocket, a shirt or hat) and in a practical manner.

Another aspect of the disclosure is the cover allows fishermen to remove lures from nets by covering each hook progressively as each hook is freed from a net.

Another aspect of the disclosure is to provide a protective housing for attachment to a fishing rod to cover several hooks, such as one, two or three hooks.

Another aspect of the disclosure is easy transportation or handling of multiple rods and lures already on the line to allow increase in hook-up ratio. Lures that are “covered” or “clipped” are easily visible to the fisherman. The compact size of the cover allows the fisherman to store the cover in multiple locations or leave the cover on the rod with the line.

It is a further aspect of the disclosure to provide a protective housing attachable to a fishing rod to enclose a lure and hook.

Still other aspects of the disclosure will become apparent upon a reading and understanding of the following detailed description.

### BRIEF DESCRIPTION OF THE DRAWINGS

FIG. 1 is a side elevational view of an existing fishing lure with three treble hooks.

FIG. 2 is a side elevational view of an existing fishing lure with two treble hooks.

FIG. 3 is a perspective view of a cover for fishing lure hooks in a closed configuration in accordance with a first embodiment of the disclosure.

FIG. 4 is a perspective view of the cover of FIG. 3 in an opened configuration.

FIG. 5 is a perspective view of the cover of FIG. 3 in an opened configuration with a fishing lure with two hooks.

FIG. 6 is a perspective view of the cover of FIG. 5 in a closed configuration with a fishing lure with two hooks.

FIG. 7 is a front elevational view of the cover of FIG. 3 in a closed configuration.

FIG. 8 is a side elevational view of the cover of FIG. 3 in a closed configuration.

FIG. 9 is a side elevational view of the cover of FIG. 8 in cross section showing the hooks inside the cover.

FIG. 10 is a side elevational view of the cover of FIG. 3 with a fishing rod attached.

FIG. 11 is a side elevational view of the cover of FIG. 3 with a fishing lure attached.

FIG. 12 is a perspective view of a cover for fishing lure hooks in a closed configuration in accordance with a second embodiment of the disclosure.

FIG. 13 is a rear perspective view of the cover of FIG. 12.

FIG. 14 is a front perspective view of the cover of FIG. 12.

FIG. 15 is a perspective view of a tackle box in a closed configuration in accordance with another embodiment of the disclosure.

FIG. 16 is a perspective view of the tackle box of FIG. 15 in an opened configuration.

FIG. 17 is a perspective view of a tapered clip with portions removed in accordance with another aspect of the disclosure.

FIG. 18 is another perspective view of the cover showing the steps in the cover cavity.

FIG. 19 is a side elevational view in cross-section showing a lip and groove arrangement of the cover.

### DETAILED DESCRIPTION OF THE DISCLOSURE

This disclosure relates to fishing lures. More particularly, it relates to a cover for housing and protecting hooks for fishing lures.

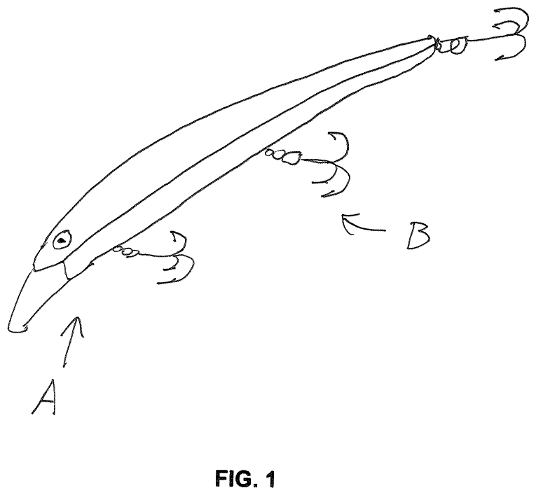

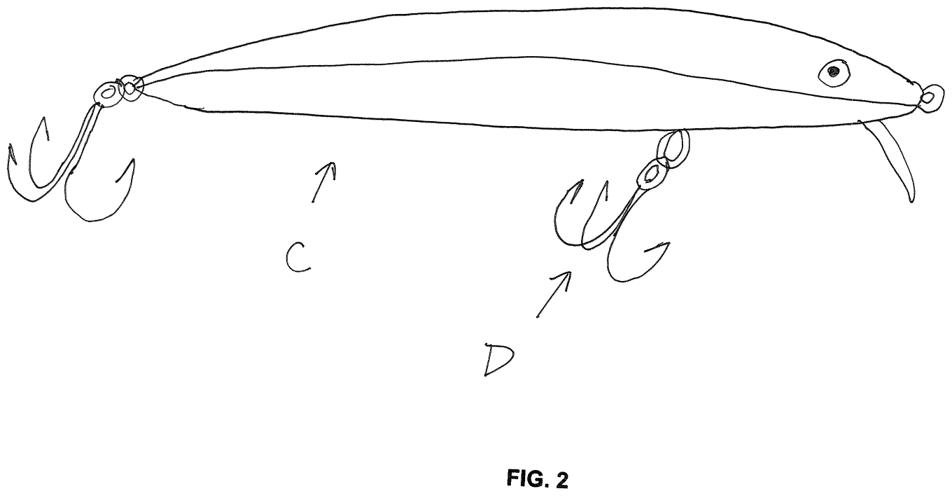

Referring to FIG. 1, an existing fishing lure A is shown which has three treble hooks B. Referring to FIG. 2 an existing fishing lure C is shown which has two treble hooks D. Of course, other fishing lures with other hooks, such as, one, two, three or more hooks is contemplated by the disclosure.

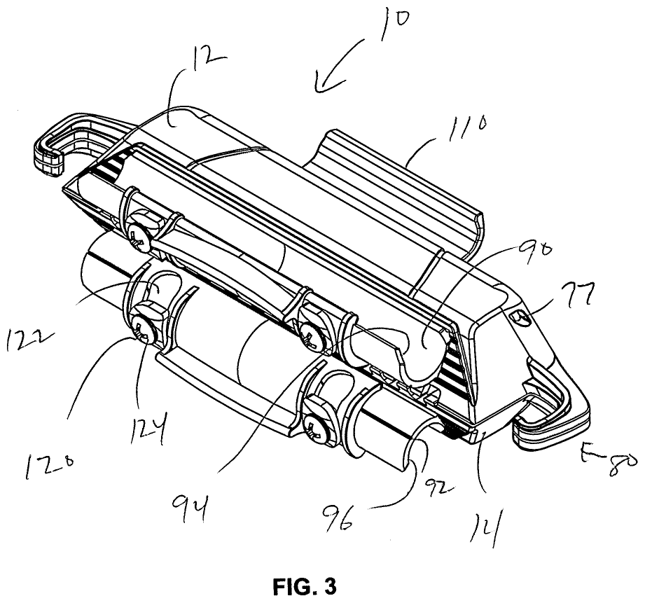

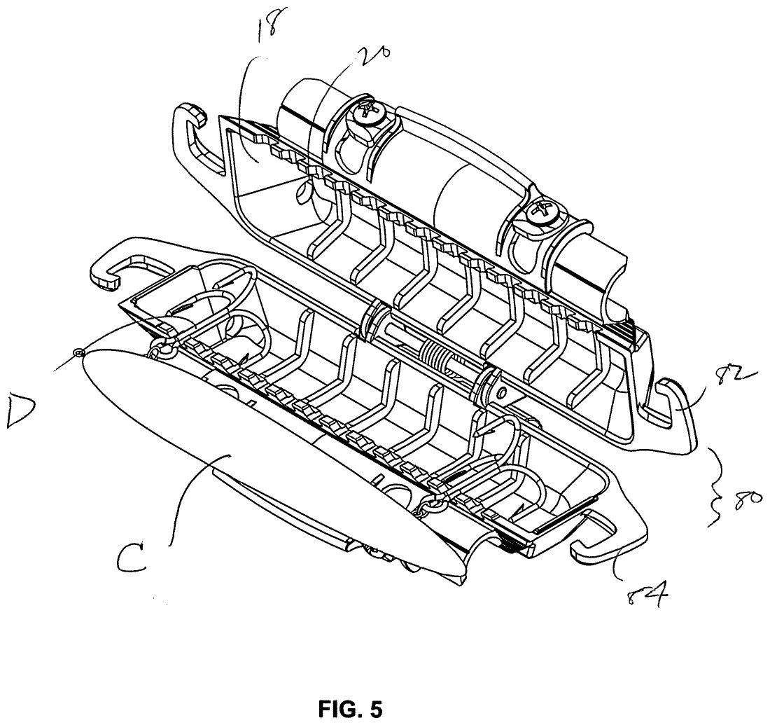

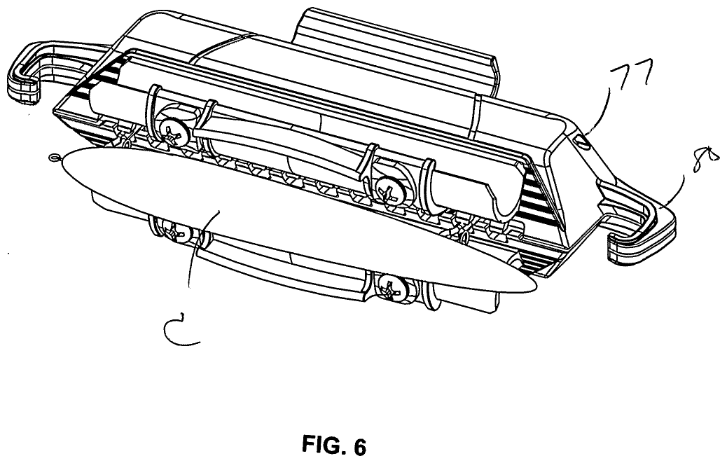

Referring now to FIGS. 3 to 11, a cover 10 for fishing lure hooks in accordance with a preferred embodiment is shown. The cover preferably has a clam shell housing having a top or first member or half 12 and a bottom or second member or half 14. A resiliently biased spring hinge assembly 16 connects the two members together. Upper member 12 has a cavity 18 and lower member 14 has a cavity 19 formed therein for accommodating hooks of a fishing lure. Within the cavities are formed a plurality of teeth 20.

The cover may be fabricated of a rigid plastic such as 75 Shore D harness/durometer, while softer plastics would not work as well.

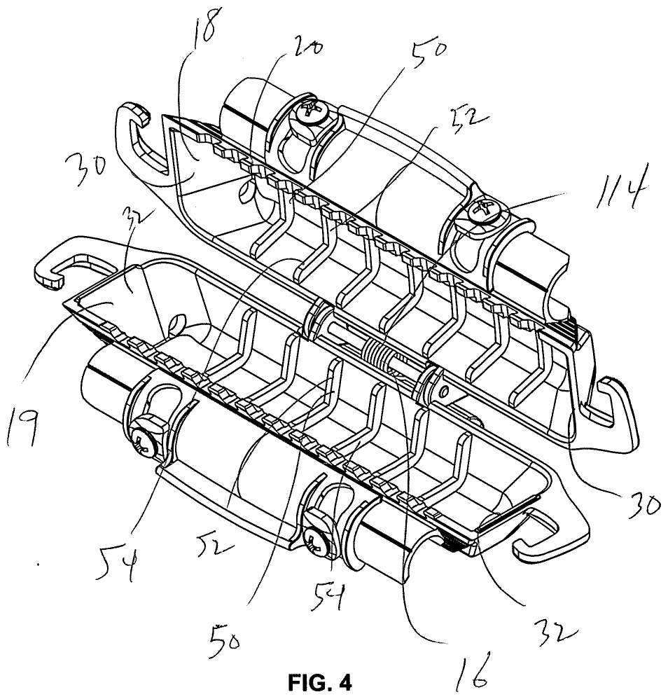

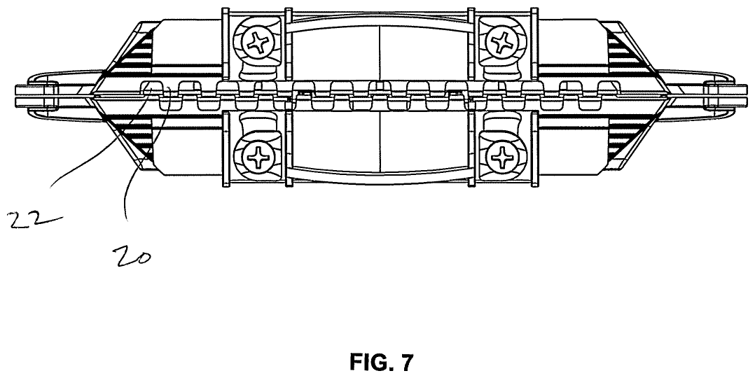

Referring to FIGS. 4 and 7, the teeth 20 are preferably nearly square edged to hold the hooks in place while allowing release of the hook. Large angled edges (such as 30 degrees or more) on the teeth allow the hook to use the tooth edge as a ramp or wedge to open up the cover enough to allow the lure to be pulled along its axis in the cover.

In contrast, totally inverted edges of the teeth would impede the release of hooks as they can rotate and their shafts could wedge between the teeth.

A preferable angle of teeth edges is about 5 degrees, but a slightly larger angle would also be effective.

A gap 22 is formed between each tooth and is large enough to fit the entire shaft of the hook between the teeth. The gaps also serve as drain holes for the clip. Enough clearance is provided to allow the cover to fully close with the hooks inside. If there were no gap or if there were a smaller gap the cover would be prevented from closing fully when it clamped onto the hook shaft. This would leave a gap all around the edges which could allow the hook barbs or prongs to poke through the cover. Extra clearance between the teeth helps avoid the hooks from getting stuck and not releasing when the cover is opened. Teeth are not provided at the distal ends of the cover so hooks cannot be provided near the end faces of the cover. If the hooks are too close to the end faces they may stick out of the ends of the cover halves.

End faces 30, 32 of the cover are angled so that the hooks do not catch on the faces 30, 32 when the lure is released such as when the lure is attached to the line and there is any amount of tension on the line. The ramps of end faces allow hooks to be easily released and the line to be easily removed. Often this is done when the cover is attached to the rod, but it does not necessarily have to be attached to the rod. This allows the user to store the lure on the fishing rod with tapered clips 90 while attached to the line and released easily to start fishing. This is done by simply rotating the cover on the pole and rod so it won't get tangled in the line and squeezing the tabs to open the cover. The tension in the line will pull the lure and its hooks towards an end face 30, 32 as soon as the teeth 20 are no longer holding the hooks. The end faces 30, 32 should preferably have a tapered angle of about 15 degrees.

Referring now to FIG. 4, internal ribs 50 are formed within the cavity 18, 19 of each cover member or half 12, 14. Short rib portions 52 are formed perpendicular to a longitudinal axis of the cover body, while longer rib portions 54 are also formed perpendicular to a longitudinal axis of the body and to the short rib portions. The ribs need to be thick enough to so that they will interfere with legs 60 of the treble hooks that are fully extended towards the top or bottom. The ribs also prevent the hooks from sliding horizontally sideways or rotating within the body. This helps keep the hooks in place when the cover is closed so the hooks cannot move around or extend out of the cover, such as allowing a barb E to extend out of the cover, which would be disconcerting and potentially harmful to the user. The ribs also provide rigid structural support for the cover body.

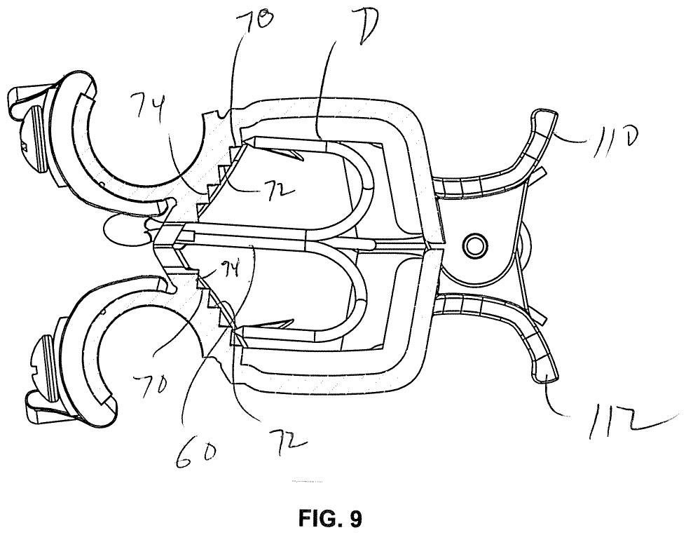

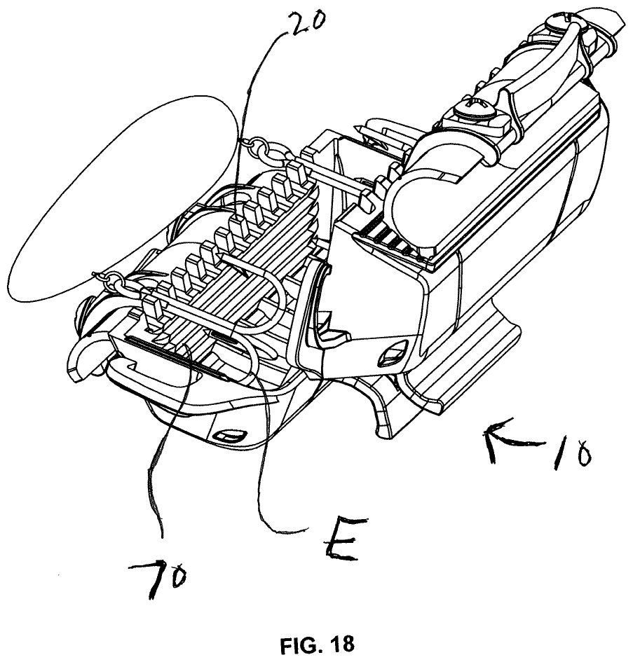

Referring now to FIGS. 9 and 18, notches 70 or “reverse stair steps” are formed on inner walls of the cover within the cavities of 18, 19 of the cover. The steps each have ledges 72 and raked back faces 74 which also serve to prevent the hooks from moving vertically in or out of the cover body. The steps 70 are formed farther from the teeth 20 laterally as well as vertically meaning that the steps are positioned for different size hooks (i.e. a hook that is longer is also usually wider which in this orientation will extend vertically. The steps result in the hooks staying in place once the cover is closed.

The steps also make it harder for the hooks to fall out of the device when it is opened, which could otherwise happen faster or easier than expected and result in dropped, lost or stuck lures.

The steps 70 are not positioned near or adjacent each end face 30, 32 to prevent hooks from getting caught and not releasing when there is tension on the line (the same scenario as for the angled end faces). Otherwise, the hook would get caught in the corner such as of a raked back end face.

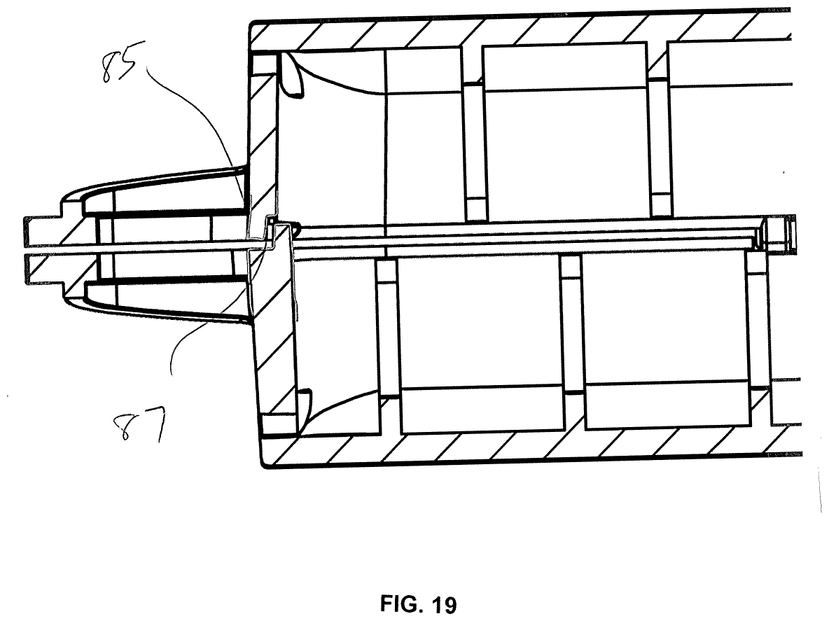

The teeth 20 and steps 70 along with a lip 85 and groove 87 arrangement (FIG. 19) are used with the end faces 30, 32 to prevent barbs E from slipping through the gap between the halves, which could happen if the hooks rotate while captured by the teeth. If the barb is sticking out of the end face when the user tries to close the device it will prevent the device from closing and will remain opened, thus alerting the user of the issue.

Drain holes 77 are provided in various locations in the cover. The drain holes on the cover allow water to drain from the cover after rinsing or cleaning.

End hooks 80 of the cover are provided at opposite ends of the cover for allowing the cover to be attached to many things for transport or storage. These include but are not limited to eyes/guides on fishing poles, nails or hooks, cable railings, loops of fabric or strapping, horizontal rods, etc. Attaching the cover to a guide on a fishing pole and tightening the line allows the cover with a lure attached to be stored in a similar way as lures are typically stored now. The end hooks 80 also allow daisy chaining multiple covers together for transport or storage.

The end hooks 80 are preferably formed of two halves 82, 84 which each form half of the thickness of the hook. The two halves 82, 84 together form a stronger hook than a single half and when they are attached to a guide, they are prevented from opening fully by the guide that they are attached to. Alternate style hooks can also be used to attach to either the fish pole or other objects.

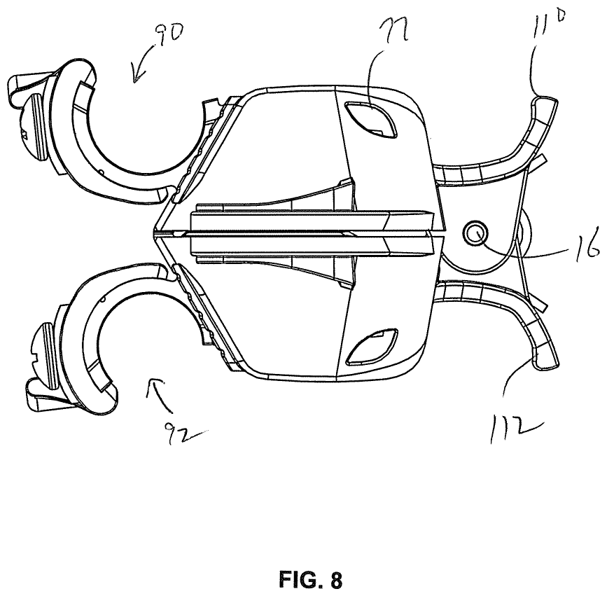

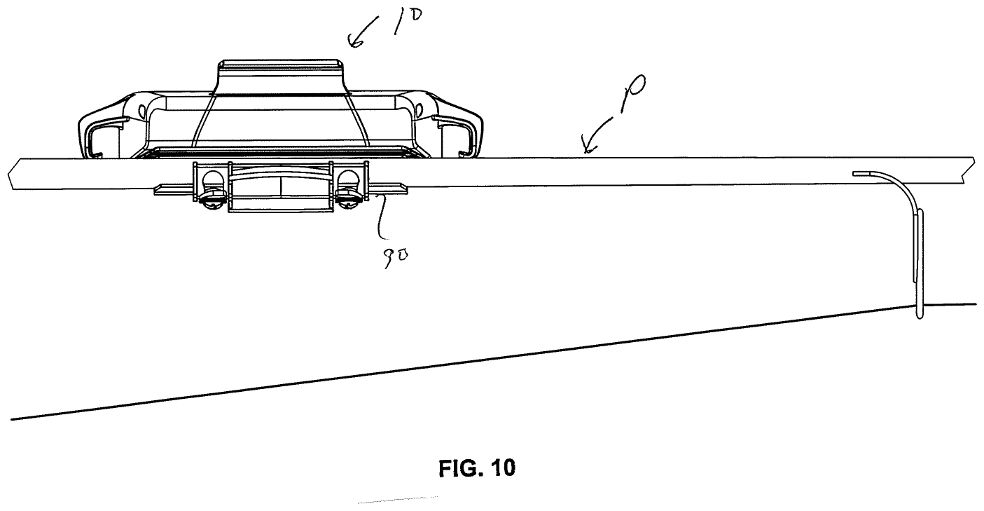

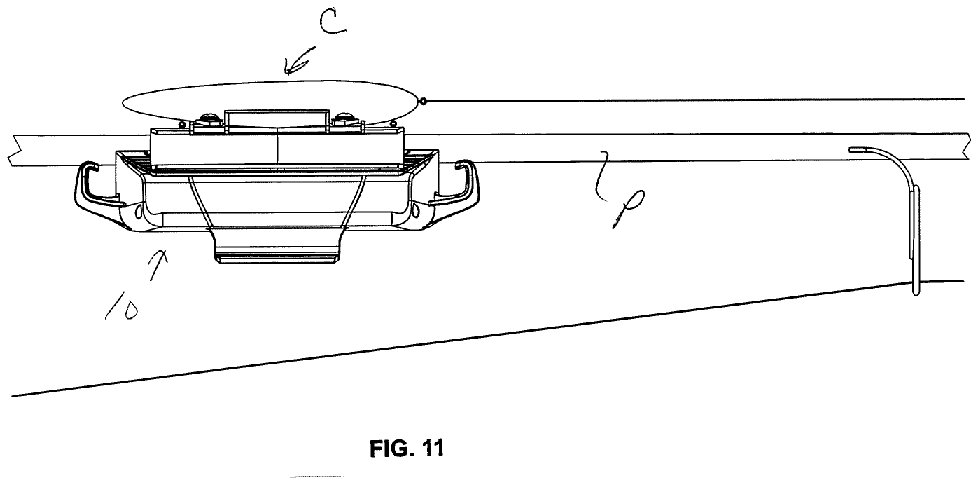

Referring now to FIGS. 8 and 10, tapered clips 90, 92 in the form of substantially c-shaped clips are provided to allow the cover to be attached to a fishing pole and to a lure C (see FIG. 11)

The clips 90, 92 have some flexibility to allow a tight or snug fit with the pole body. Since fishing poles are typically tapered, a straight clip would only be able to connect with a portion of the pole and would not provide a secure fit. The clips 90, 92 are tapered to match or be very close to matching the taper in the fishing pole body. Referring to FIGS. 10 and 11, the user can push the clip 90, 92 over the fishing pole diameter where the diameter is smaller, then the clip slides down the fishing pole to a larger diameter portion of the pole which then wedges the clip to the pole and creates a tight fit. That is, the fit is tight enough that if a lure is attached to a line it is held by the cover, then the line can be tightened enough to take up slack and secure it into place without the clip becoming loose. This arrangement still allows the cover to rotate around the rod without loosening.

Referring to FIG. 8, mirrored tapered clips 90, 92 are provided. Since a taper would occur in a certain direction, a simple tapered clip would necessitate the user placing the hook on a certain orientation while may not always happen. Thus, to eliminate user error, the tapered clip is mirrored about the narrow end so it can be placed on the rod in any orientation. This creates an hourglass or butterfly shaped clip, that is, the bottom section of the clip will be fully engaged with the pole, with the top section flaring away from the pole.

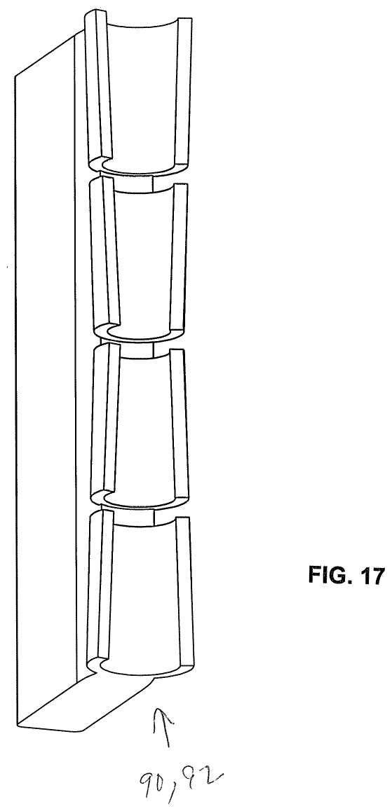

In FIG. 8, an exaggerated taper angle of the clips 90, 92 is shown to make it visible, as the actual taper is quite slight (i.e. about 0.2 degrees). The tapered clip also does not need to be fully contiguous to function; that is, gaps can be formed along its length (see FIG. 17). While the gaps would eliminate material, they also allow each clip section to flex independently which can help fit poles which have a taper that deviates from the taper of the clip. This also allows a part of the upper section to be engaged.

Referring now to FIG. 17, portions of the clip 90, 92 may be removed so long as they still allow the remaining portions to oppose one another and grip. The clips may be available in multiple sizes to accommodate different poles. In the present disclosure the arrangement is two different sized clips to accommodate a wide range of poles. Differently sized clips can be color coded for quick identification. Ideally the clips will be sized to fit on a rod between the reel and the first guide, which makes it easy for the user to access the cover. On most poles the line is further from the pole since it is coming from the reel, which makes it less likely to interfere with the cover. The cover can also be attached to segments elsewhere on the pole.

The clips 90, 92 are located on the same side as the teeth 20 to avoid confusion with squeeze tabs 110, 112 (see FIG. 3) which are located on opposite sides of the cover pressed together by the users fingers using one hand about a spring biased hinge 114 to open the cover and separate the two cover halves 12, 14.

Referring now to FIG. 10, once the cover is attached to the pole, a rotating lock mechanism 120 is used to further secure the cover to the pole. The lock mechanism includes a groove 122 and a screw or tab 124 which is tightened and loosened to further secure or release the cover from the pole. With the tapered clips 90, 92 if the pole is slid along the clips it could become loose as the diameter of the pole gets smaller. The lock mechanism helps prevent the cover from becoming loose from the pole. Lines on the clip indicate when the cover is in the fully locked position.

The user slides the lock 124 so that a finger goes between the opening tabs. This prevents them from coming together which prevents the cover from opening, the lock also prevents accidental opening of the cover or accidentally pressing the squeeze tabs 110, 112 and opening the cover.

The tapered clips 90, 92 may have rubber added to them to further secure the rod to the clips. The rubber could be added in a pattern along the length, making sure that the outer tips have contact all the way around the clip, radial bands, etc.

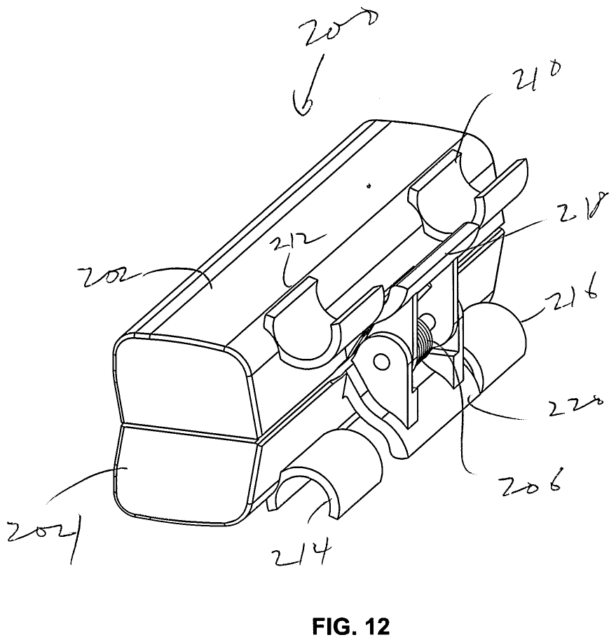

Referring to FIG. 12, an alternate fish lure hook cover 200 is shown. The cover has two halves 202, 204 connected by a spring hinge 206. Clips 210, 212,214, 216, are formed on the same side as the hinge to connect the cover to the fish pole. Squeeze tabs 218, 220 are formed on opposite sides of the hinge 206 to inwardly push the halves open.

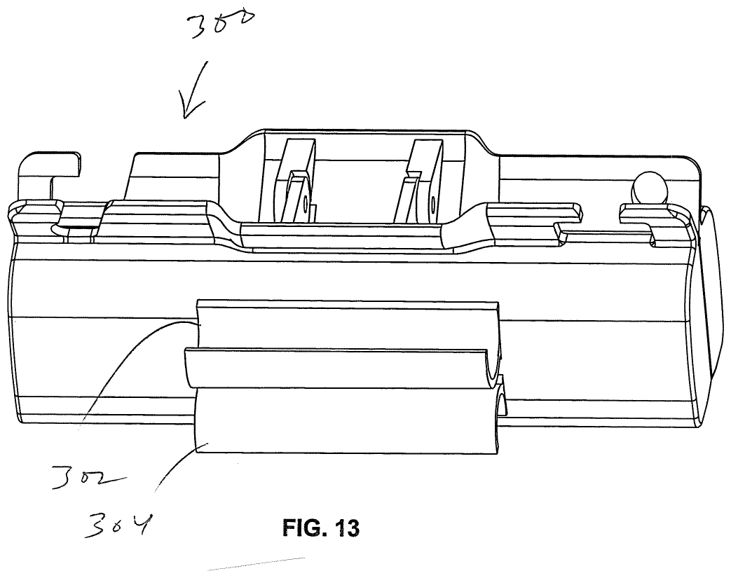

FIG. 13 shows a cover 300 which has tapered clips 302, 304 found in the middle of the cover tube.

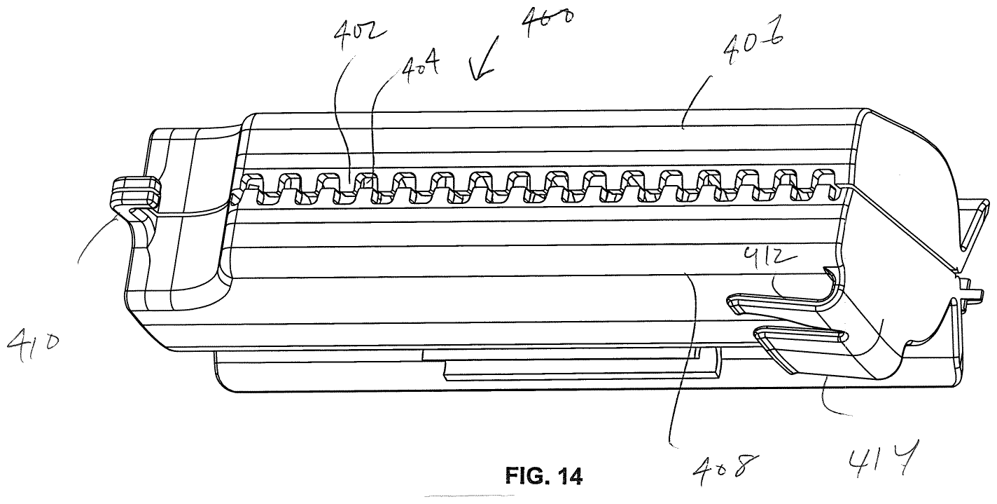

FIG. 14 shows a cover 400 which has teeth 402 and gap 404 formed in each cover half 406, 408. Various clips 410, 412, 414 are found on different portions of the cover to secure the cover to a variety of objects, such as fishing poles, clothing, etc.

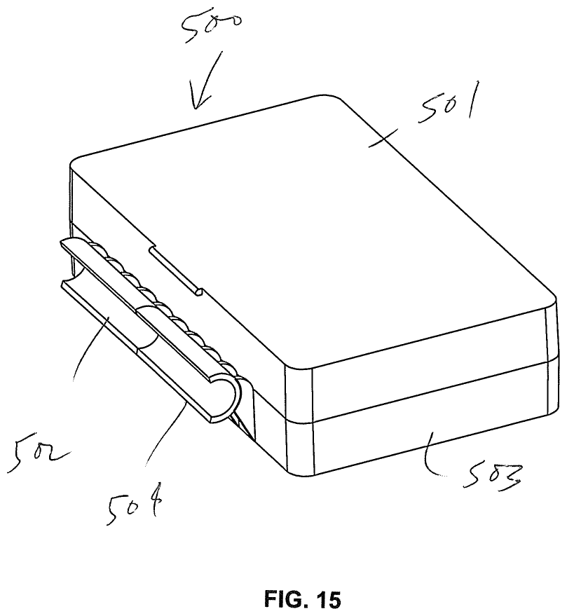

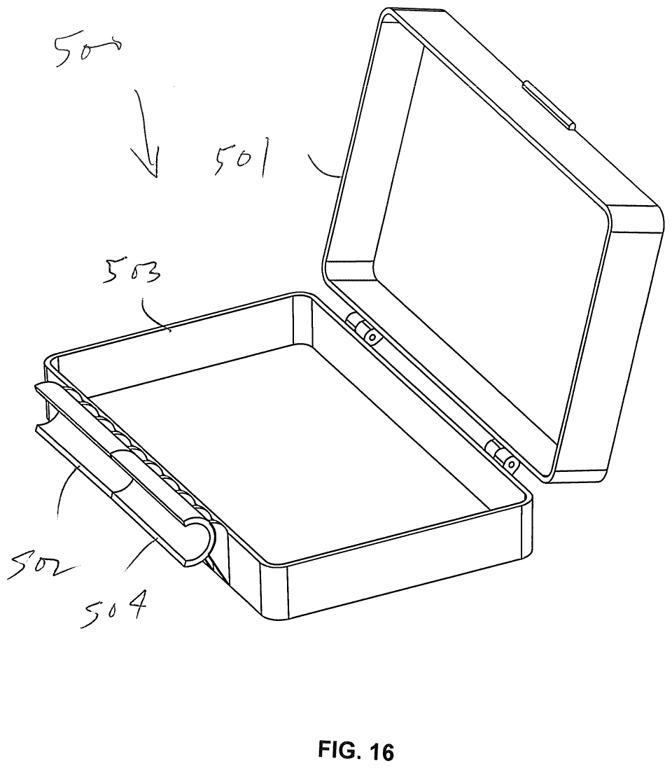

Referring now to FIGS. 15 and 16, a tackle box 500 having an upper body 501 and a lower body 503 can be added to a fish pole. The box would also have tapered clips 502, 504, to secure the box to the fish pole. The box can accommodate various fishing accessories.

Floaties can be added to the cover to allow it to float if it falls in the water. Carabiners can be added on the hooks allow daisy chaining of the hooks.

The preferred embodiment has been described with respect to the embodiments. Obviously, modifications and alterations will occur to others upon a reading and understanding of the preceding detailed description. It is intended that the embodiments be construed as including all such modifications and alternatives in so far as they come within the scope of the appended claims or the equivalent thereof.

1. A cover for hooks for fishing lures, comprising:
a body having a first half and a second half,
wherein said first half and said second half are connected together by a resilient biased hinge;
a plurality of teeth are formed on said first half and said second half;
wherein a gap is formed between each of said teeth;
wherein said first half and said second half each comprises a cavity for retaining one or more associated hooks of a fishing lure; and
said first half and said second half each comprises sloped end faces to facilitate removal and avoiding piercing of said hook and said fishing lure from the cover.

2. The cover of claim 1 wherein said cover is made of rigid plastic of 75 shore D hardness/Durometer.

3. The cover of claim 1, wherein said teeth have angled edges of about 5 degrees.

4. The cover of claim 1, wherein ribs are formed within the cavities of said first half and said second half to prevent longitudinal and rotational movement of said hook.

5. The cover of claim 4, wherein each of said ribs comprises a short portion and a long portion each perpendicular to a longitudinal axis of said cover.

6. The cover of claim 1, further comprising notches having ledges and back faces formed on inner walls of said first half and said second half, wherein said notches prevent the hooks from moving within the cover.

7. The cover of claim 1, further comprising drain holes formed on one or more corners of the cover to facilitate draining water from said cover.

8. The cover of claim 1, further comprising end hooks provided at opposite ends of said cover to attach said cover to an associated fishing pole.

9. The cover of claim 1, further comprising a pair of clips for attaching said cover to an associated fishing pole.

10. The cover of claim 9, wherein each of said clips are is substantially C-shaped.

11. The cover of claim 9, wherein each of said clips is tapered to facilitate securing said cover to the fishing pole.

12. The cover of claim 1, further comprising a locking mechanism to secure said cover to an associated fishing pole.

13. The cover of claim 12, wherein said locking mechanism comprises elongated slots and fasteners positioned within said slots so that said fasteners slid along said slots until said fasteners contact an edge of said slots and then secure said cover to the fishing pole.

14. A cover for hooks of fishing lures, comprising:
a body having a first half and a second half, connected together by a resilient biased hinge;
a plurality of teeth are formed on said first half and said second half;
wherein said first half and said second half each comprises a cavity for retaining a hook of a fishing lure and ribs for securing hooks within said cover; and tapered clips for securing said cover to an associated fishing pole.

15. The cover of claim 14, further comprising end hooks provided at opposite ends of said cover to attach said cover to a fishing pole.

16. The cover of claim 14, wherein each of said clips are substantially C-shaped.

17. The cover of claim 14, further comprising a locking mechanism to secure said cover to the fishing pole.

18. The cover of claim 17, wherein said locking mechanism comprises elongated slots and fasteners wherein said fasteners are slid along said elongated slots and then tightened to secure said cover to the fishing pole.
